(19) United States
(12) Patent Application Publication
(10) Pub. No.: US 2026/0121579 A1
(43) Pub. Date: Apr. 30, 2026

(54) HYDROFORMED A-FRAME SOLAR TRACKER PILES

(71) Applicant: Nextracker LLC, Fremont, CA (US)

(72) Inventors: Ho Shing Lau, San Jose, CA (US); Ryan Patel, Pleasanton, CA (US)

(21) Appl. No.: 19/367,447

(22) Filed: Oct. 23, 2025

Related U.S. Application Data
(60) Provisional application No. 63/712,926, filed on Oct. 28, 2024.

(51) Int. Cl. H02S 20/32

(52) U.S. Cl. CPC H02S 20/32

(57) ABSTRACT

Described herein is an A-frame support for a solar tracker system. The A-frame support includes multiple legs each partially embedded in an underlying ground. For example, the A-frame support includes a first leg and a second leg. The first leg is connected to the second leg, cither integrally or via a connecting member, to form the A-frame support.

### RELATED APPLICATIONS

This application claims the benefit of U.S. Provisional Patent Application No. 63/712,926, filed Oct. 28, 2024, the entire contents of which are incorporated herein by reference.

### TECHNICAL FIELD

This disclosure relates generally to solar power generation systems, and more particularly, to support structures for solar arrays within a solar tracking system.

### BACKGROUND

Solar panels can convert sunlight into energy. As an example, solar thermal panels often convert electromagnetic radiation from the sun into thermal energy for heating homes, running certain industrial processes, or driving high grade turbines to generate electricity. As another example, solar photovoltaic panels convert sunlight directly into electricity for a variety of applications. Solar panels are generally composed of an array of solar cells, which are interconnected to each other. The cells are often arranged in series and/or parallel groups of cells in series. Accordingly, solar panels have great potential to benefit our nation, security, and human users. They can even diversify our energy requirements and reduce the world's dependence on oil and other potentially detrimental sources of energy.

Solar tracking systems can be used to dynamically orient a plurality of solar modules, for instance, by moving the solar modules throughout the course of a given day to track the movement of the sun and thereby increase the efficiency and productivity of the solar modules. However, because solar tracking systems apply motive force to move the solar modules, resulting forces can be imparted on the piles that support the movable solar modules. In addition, the solar modules can experience natural forces in the field, such as wind loads, which can create additional acting forces on the piles that support the movable solar modules.

Conventional methods of manufacturing solar tracker piles (e.g., supports) typically include methods such as welding, machining, casting, and bolted assemblies. Welding often involves assembling frames from multiple parts, which can introduce stress points and require additional finishing processes. Machining can be material-intensive and results in higher costs, as components are often carved from solid blocks of metal. Casting, while useful for creating foundational elements, may have limitations in design flexibility and can result in heavier components. Bolted assemblies, on the other hand, lead to longer assembly times and potential points of failure, as the connections can become loose over time.

In view of these costly processes and designs, solar tracker piers and foundations that alleviate the need for costly and time-consuming processes involving heavy machinery and reduce the amount of material and labor required for installation are needed.

### SUMMARY

In general, the present disclosure relates to support structures for solar arrays within a solar tracking system.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is an elevation view of a solar tracker provided in accordance with the present disclosure;

FIG. 2A is a perspective view of an A-frame support for a solar tracker system;

FIG. 2B is a front side view of the A-frame support, as in FIG. 2A;

FIG. 2C is a side view of the A-frame support, as in FIG. 2A;

FIG. 2D is a bottom side view of the A-frame support, as in FIG. 2A, including Circle A;

FIG. 3A is a perspective view of an A-frame support for a solar tracker system;

FIG. 3B is a front side view of the A-frame support, as in FIG. 3A;

FIG. 3C is a side view of the A-frame support, as in FIG. 3A;

FIG. 3D is a bottom side view of the A-frame support, as in FIG. 3A, including Circle B;

FIG. 4A is a perspective view of an A-frame support for a solar tracker system;

FIG. 4B is a front side view of the A-frame support, as in FIG. 4A, including Circle C;

FIG. 4C is a side view of the A-frame support, as in FIG. 4A;

FIG. 4D is a bottom side view of the A-frame support, as in FIG. 4A, including Circle D;

FIG. 5A is a perspective view of an A-frame support for a solar tracker system;

FIG. 5B is a front side view of the A-frame support, as in FIG. 5A, including Circle E;

FIG. 5C is a side view of the A-frame support, as in FIG. 5A;

FIG. 5D is a bottom side view of the A-frame support, as in FIG. 5A;

FIG. 6A is a perspective view of an A-frame support for a solar tracker system;

FIG. 6B is a front side view of the A-frame support, as in FIG. 6A, including Circle F;

FIG. 6C is a side view of the A-frame support, as in FIG. 6A;

FIG. 6D is a bottom side view of the A-frame support, as in FIG. 6A;

FIG. 7A is a perspective view of an A-frame support for a solar tracker system;

FIG. 7B is a front side view of the A-frame support, as in FIG. 7A, including Circle G;

FIG. 7C is a side view of the A-frame support, as in FIG. 7A;

FIG. 7D is a bottom side view of the A-frame support, as in FIG. 7A;

FIG. 8A is a perspective view of an A-frame support for a solar tracker system;

FIG. 8B is a front side view of the A-frame support, as in FIG. 8A, including Circle H;

FIG. 8C is a side view of the A-frame support, as in FIG. 8A;

FIG. 8D is a bottom side view of the A-frame support, as in FIG. 8A;

FIG. 9A is a perspective view of an A-frame support for a solar tracker system;

FIG. 9B is a front side view of the A-frame support, as in FIG. 9A, including Circle I;

FIG. 9C is a side view of the A-frame support, as in FIG. 9A;

FIG. 9D is a bottom side view of the A-frame support, as in FIG. 9A;

FIG. 10A is a perspective view of an A-frame support for a solar tracker system;

FIG. 10B is a front side view of the A-frame support, as in FIG. 10A;

FIG. 10C is a front view of the A-frame support illustrating a coupling of a top portion and support members of the A-frame support, as in FIG. 10A;

FIG. 10D is a perspective view of a top portion of the A-frame support, as in FIG. 10A;

FIG. 10E is an enlarged, perspective view of a first end of a support member of the A-frame support, as in FIG. 10A;

FIG. 11A is a perspective view of an A-frame support for a solar tracker system;

FIG. 11B is a front side view of the A-frame support, as in FIG. 11A, including Circle J;

FIG. 11C is a side view of the A-frame support, as in FIG. 11A;

FIG. 11D is a bottom side view of the A-frame support, as in FIG. 11A;

FIG. 12A is a perspective view of an A-frame support for a solar tracker system;

FIG. 12B is a front side view of the A-frame support, as in FIG. 12A, including Circle K;

FIG. 12C is a side view of the A-frame support, as in FIG. 12A; and

FIG. 12D is a bottom side view of the A-frame support, as in FIG. 12A.

### DETAILED DESCRIPTION

The following detailed description is exemplary in nature and is not intended to limit the scope, applicability, or configuration of the disclosure in any way. Rather, the following description provides some practical illustrations for implementing examples of the present disclosure. Those skilled in the art will recognize that many of the noted examples have a variety of suitable alternatives.

Embodiments disclosed herein include various devices, systems, and methods relating to solar tracker foundations. Certain embodiments disclosed herein relate to solar tracker A-frame supports configured to facilitate improved structural stability for solar tracking systems. Certain embodiments disclosed herein can improve solar tracking system structural stability while increasing the efficiency of solar tracking foundation installation and reducing costs (e.g., foundation and/or support material costs) associated with solar tracker foundations and supports.

Embodiments disclosed herein may be formed via a hydroforming process. Hydroforming may be a material-efficient process as it deforms the material rather than cutting it, minimizing waste and ultimately reducing costs. This is particularly beneficial in the context of solar energy, where optimizing both performance and cost is crucial. Further, hydroforming may enhance strength and durability of the components it produces. For example, hydroformed parts may exhibit improved mechanical properties due to the uniform distribution of material, which may lead to frames that better withstand environmental stresses compared to those made using traditional methods, and hydroforming may reduce assembly time, as it often allows for the creation of complex shapes in a single piece, thereby decreasing the number of components required. This simplification not only speeds up production but also contributes to a more streamlined assembly process.

Hydroforming may enhance the design of an A-frame support, such as those described herein. For example, one of the benefits of hydroforming is the ability to create complex shapes that are often difficult or impossible to achieve with traditional manufacturing methods. Thus, hydroforming allows for more efficient and optimized designs for A-frame supports for solar tracker systems, by improving their structural integrity while also reducing weight. Further, components formed via hydroforming may include a seamless finish, which may be aesthetically desirable.

Hydroforming solar tracker components, such as those described herein, may offer superior design flexibility, such as, allowing for intricate shapes that create more streamlined and integrated solutions. Additionally, the resulting structures tend to be lighter, improving overall tracker efficiency and reducing foundation requirements. The stress distribution in hydroformed parts typically leads to better structural performance compared to welded joints, which can be weaker due to heat-affected zones. While hydroforming may entail higher initial setup costs, the reduction in material waste and labor can result in lower overall production costs, especially in high-volume applications. Manufacturing solar tracker frames via a hydroforming process may present a compelling alternative to traditional manufacturing methods. The advantages it offers in design capabilities, material efficiency, and structural integrity may contribute to more effective solar energy solutions, ultimately benefiting the renewable energy sector.

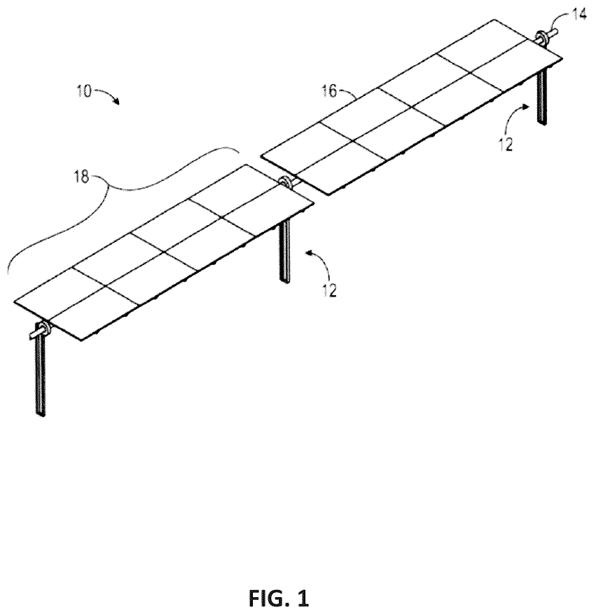

FIG. 1 is an elevation view of a common arrangement of a solar tracker 10 provided in accordance with the present disclosure. In some applications, a plurality of solar trackers 10 may be arranged in a north-south longitudinal orientation to form rows of a solar array. The solar tracker 10 may be formed of a plurality of bays 20 defined by the distance between ground piles 18 (generally referenced herein as piles 18). The ground piles 18 may be disposed in spaced relation to one another and partially embedded in the earth. In some examples, the ground piles 18 may be tubular support members, or A-frame supports, and/or may be configured to couple to A-frame supports. FIG. 1 illustrates two bays 20 of the solar tracker 10. However, it will be appreciated that the solar tracker 10 may include four bays, six bays, ten bays, twenty bays, or any other suitable number of bays as desired. At each pile 18 is either a bearing 22 or generally near the center of the solar tracker 10 a drive mechanism 16. Each of the bearings 22 and the drive mechanism 16 are supported by one of the piles 18. Activation of the drive mechanism rotates a torque tube 14 about an axis of rotation and thus rotates one or more solar modules 12 mounted to the torque tube 14 such that the solar modules 12 can be oriented to a desired position. That desired position may be to a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

The torque tube 14 is sized (e.g., diameter, wall thickness, material) such that sag between the piles 18 is reduced or substantially eliminated and to absorb torsional loads applied to the torque tube 14 by wind loading. In addition, since there is often just a single drive mechanism 16, the specifications for the torque tube 14 may desire to eliminate twist of the torque tube 14 along its length. Twisting of the torque tube 14 would result in the solar modules 12 being oriented differently from what is desired, and thus again reduce the output and efficiency of the solar tracker 10, particularly, as the solar tracker 10 is rotated to the extreme angles of permitted range (e.g., +/−60 degrees or more).

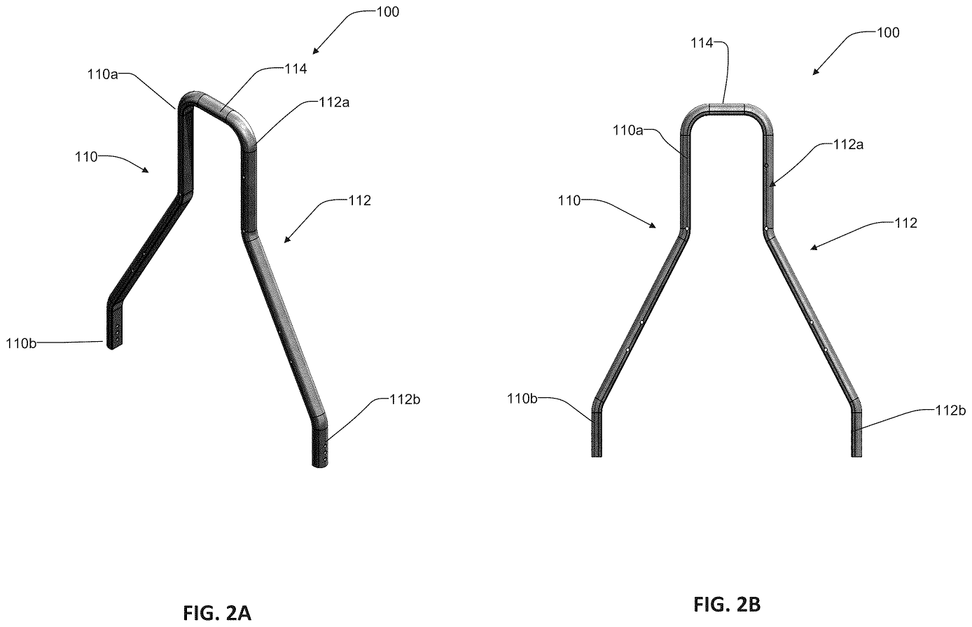

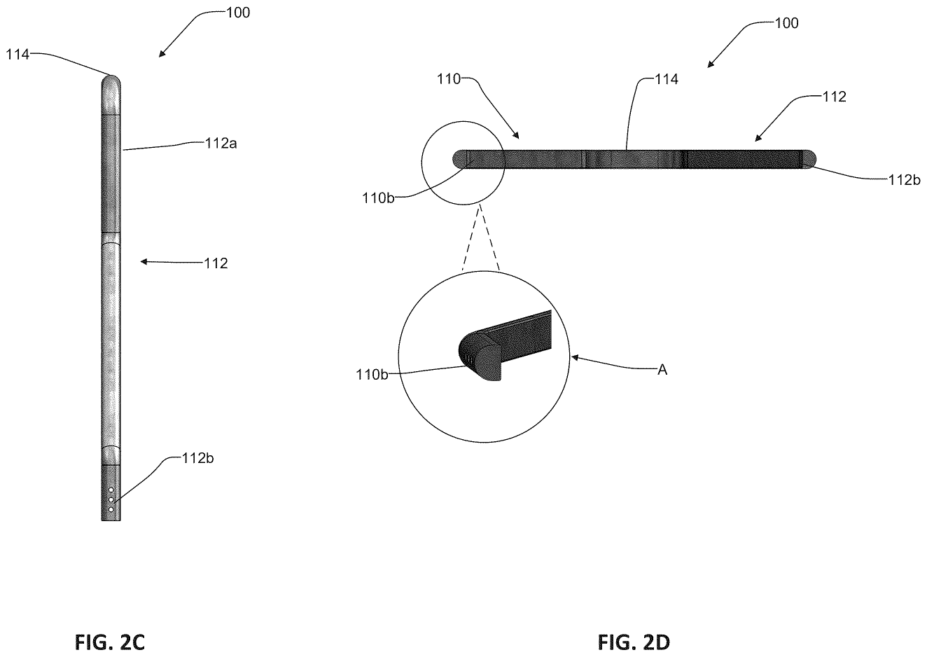

FIGS. 2A to 2D illustrate an example A-frame support 100 for a solar tracker system, such as solar tracker 10 of FIG. 1. The A-frame support 100 may include multiple legs each partially embedded in an underlying ground. For example, the A-frame support 100 may include a first leg 110 and a second leg 112. The first leg 110 may be connected to the second leg 112, either integrally or via a connecting member 114, to form the A-frame support 100. As shown in FIGS. 2A to 2D, the connecting member 114 is formed integrally with the first leg 110 and the second leg 112. The first leg 110 may have a first leg proximal end 110a and a first leg distal end 110b, and the second leg 112 may have a second leg proximal end 112a and a second leg distal end 112b. In some cases, the first leg distal end 110b of the first leg 110 may be open and the second leg distal end 112b of the second leg 112 may be open. In other cases, the first leg distal end 110b of the first leg 110 may be closed and the second leg distal end 112b of the second leg 112 may be closed. In some cases, one of the first leg distal end 110b or the second leg distal end 112b may be open and the other of the first leg distal end 110b or the second leg distal end 112b may be closed. In some cases, although not explicitly shown, a mount may be positioned proximate the first leg distal end 110b or the second leg distal end 112b, and the mount may include a series of one or more mounting holes that extend through the first leg distal end 110b or the second leg distal end 112b, respectively. In some examples, the first leg distal end 110b and the second leg distal end 112b may be configured to be nested within a concrete foundation. In some examples, the first leg distal end 110b and the second leg distal end 112b may be configured to engage with a ground anchor and/or a ground pile via the mounting holes. These are just examples.

The A-frame support 100 may include a D-shape cross-section throughout the entirety of the A-frame support 100. For example, the first leg 110, the second leg 112, and the connecting member 114 may each include a D-shape cross-section and may each include the same or a similar diameter, as shown in FIGS. 2A to 2D. Although this may not always be the case. In some cases, the first leg proximal end 110a may have an outer diameter that is different than an outer diameter of the first leg distal end 110b (e.g., smaller than or larger than). In some cases, the second leg proximal end 112a may have an outer diameter that is different than an outer diameter of the second leg distal end 112b (e.g., smaller than or larger than). In some cases, the connecting member 114 may include an outer diameter that is different than the first leg proximal end 110a, the first leg distal end 110b, the second leg proximal end 112a, and the second leg distal end 112b. In some cases, the A-frame support 100 may include an oval cross-section, a hexagonal cross-section, a circular cross-section, a square cross-section, a rectangular cross-section, a triangular cross-section, a W-cross-section, a polygonal cross-section, or any other suitable cross-section as desired.

The A-frame support 100 may be formed from aluminum, brass, carbon, stainless steel, copper, or other metal alloys. To the extent the A-frame support 100 is formed via a hydroforming process, as described herein, the A-frame support 100 may be formed of a material and a thickness appropriate for forming the particular components described herein. For example, the first leg 110 and the second leg 112, and the connecting member 114 may be formed by a hydroforming process of a hollow tube. In such cases, the hollow tube may be fed into and held by the die. Pressurized fluid may then be applied to the inside of the hollow tube to expand the hollow tube to fill the die, thereby creating the one or more legs of the A-frame support 100, such as for example, the first leg 110 and the second leg 112, and the connecting member 114. Further, by using the hydroforming process, the one or more legs and the connecting member may include one or more cross-sectional shapes. For example, as shown in Circle A in FIG. 2D, the one or more legs may include the first leg 110 and the second leg 112 having a D-shaped cross-section. Further, the connecting member 114 may include a D-shaped cross-section. Other types of cross-sections, such as circular, oval, etc. will be discussed further herein. These are just examples.

Forming the A-frame support 100 via the hydroforming process allows for the design to have multiple thickness in different areas as needed. Moreover, any desired holes (e.g., mounting holes) and/or slots needed within the A-frame support 100 may be added directly during the hydroforming process rather than as a post-processing step. Further, formation of the hydroformed A-frame support 100 via the hydroforming process, as discussed herein, may streamline the process of adding retention features (e.g., support blades, brackets, stops, threads, etc.) to the A-frame support 100 during the manufacturing process. In some examples, the various parts of the A-frame support 100 (e.g., the connecting member 114, the first leg 110, the second leg 112) may be formed as one continuous component via a hydroforming process. In some examples, the various parts of the A-frame support 100 (e.g., the connecting member 114, the first leg 110, the second leg 112) may each be formed independently via a hydroforming process and may be attached together to form the A-frame support 100. For example, the various parts of the A-frame support 100 (e.g., the connecting member 114, the first leg 110, the second leg 112) may be attached via welding, adhesives, etc. The A-frame support 100 may be advantageous in diverse soil conditions (e.g., sandy soil, clay soil, silt soil, peat soil, loam soil, among others) by providing reliable support for solar trackers 10 in rural and/or urban environments.

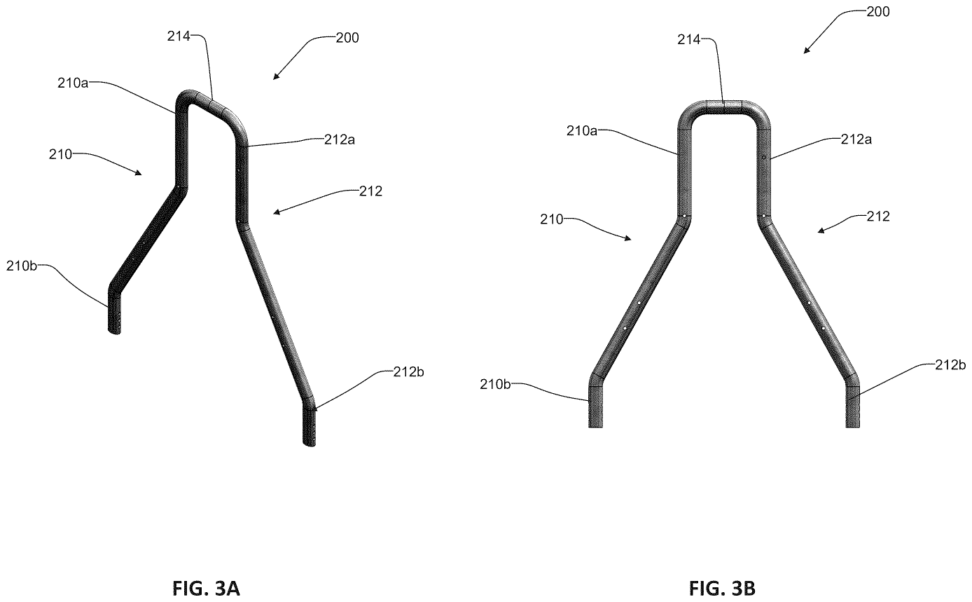

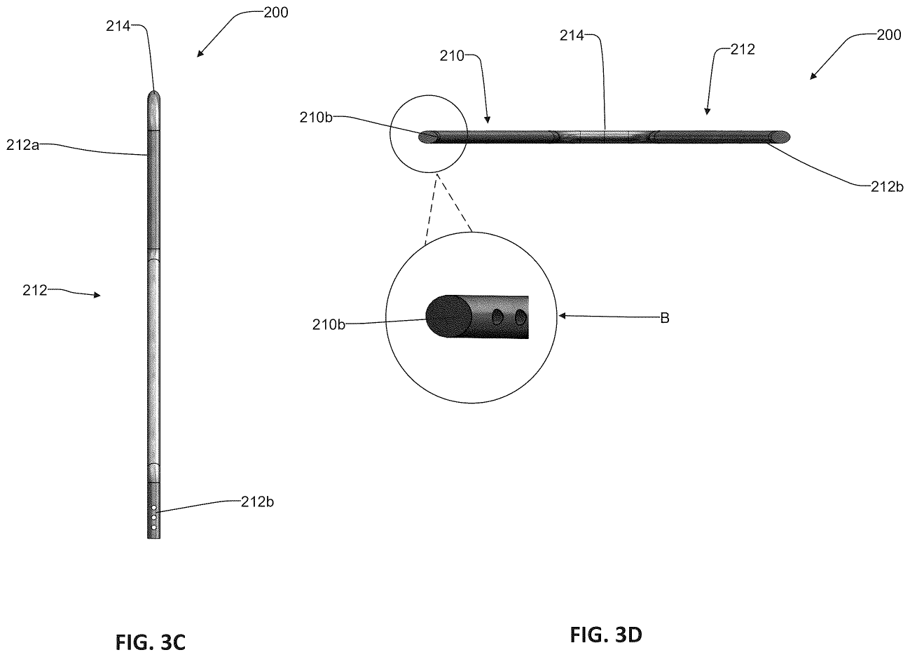

FIGS. 3A to 3D illustrate an example A-frame support 200 for a solar tracker system, such as solar tracker 10 of FIG. 1. The A-frame support 200 is like the A-frame support 100 shown in FIGS. 2A to 2D, except for the cross-sectional shape of the first leg 210, the second leg 212, and the connecting member 214. As shown in Circle B in FIG. 3D, the one or more legs may include the first leg 210 and the second leg 212 having an oval cross-section, and the connecting member 214 may further include an oval cross-section. In such cases, the various components of the A-frame support 200 may be formed as one continuous component via a hydroforming process, however this may not always be the case.

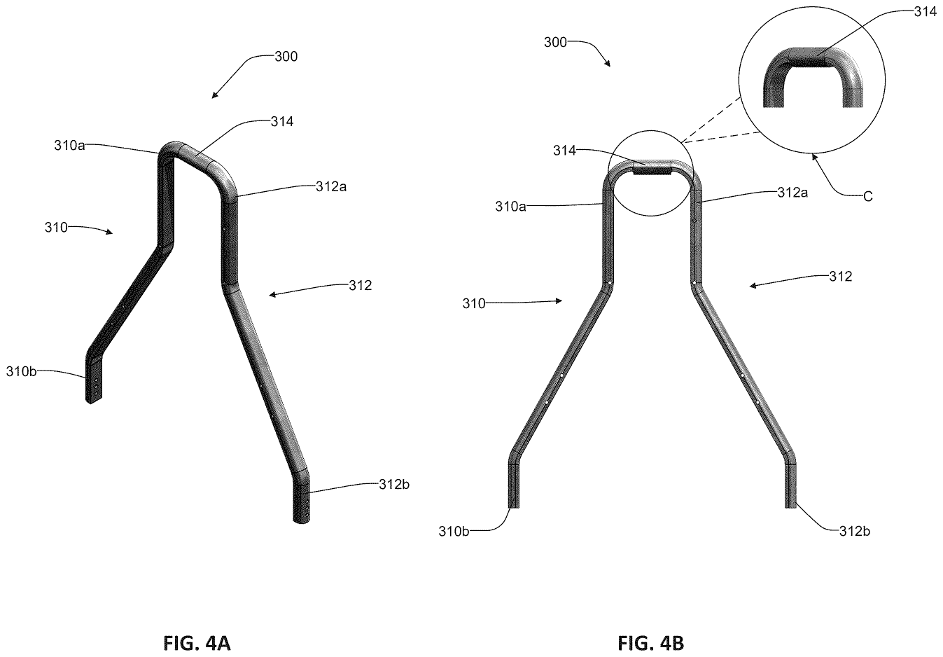

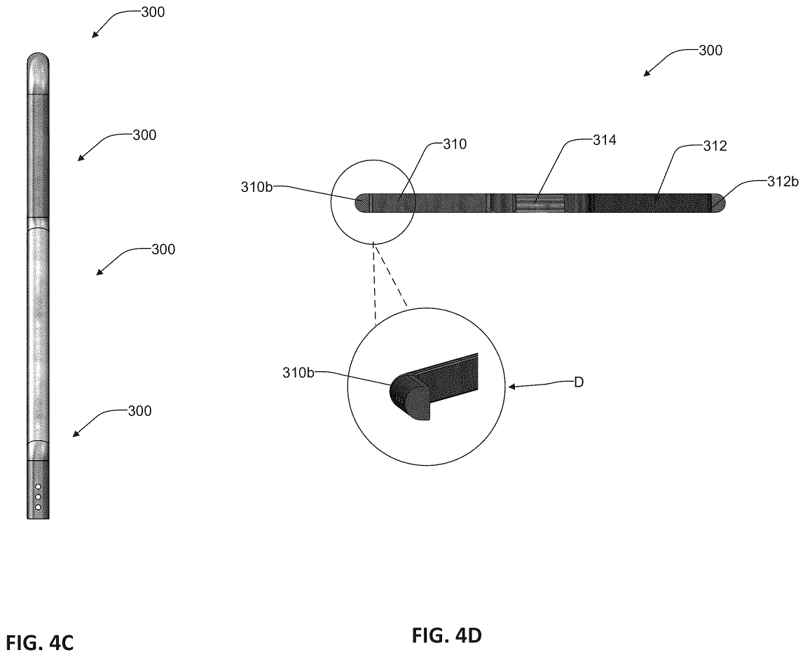

FIGS. 4A to 4D illustrate an example A-frame support 300 for a solar tracker system, such as solar tracker 10 of FIG. 1. The A-frame support 300 is like the A-frame support 100 shown in FIGS. 2A to 2D, except that while the first leg 310 and the second leg 312 include a D-shape cross-section, as shown in Circle D in FIG. 4D, the connecting member 314 may include a circular cross-section, as shown in Circle C in FIG. 4B. In such an example, the first leg 310, the second leg 312, and the connecting member 314 may each be formed via a hydroforming process as individual components and may be attached together to form the A-frame support 300, however this may not always be the case.

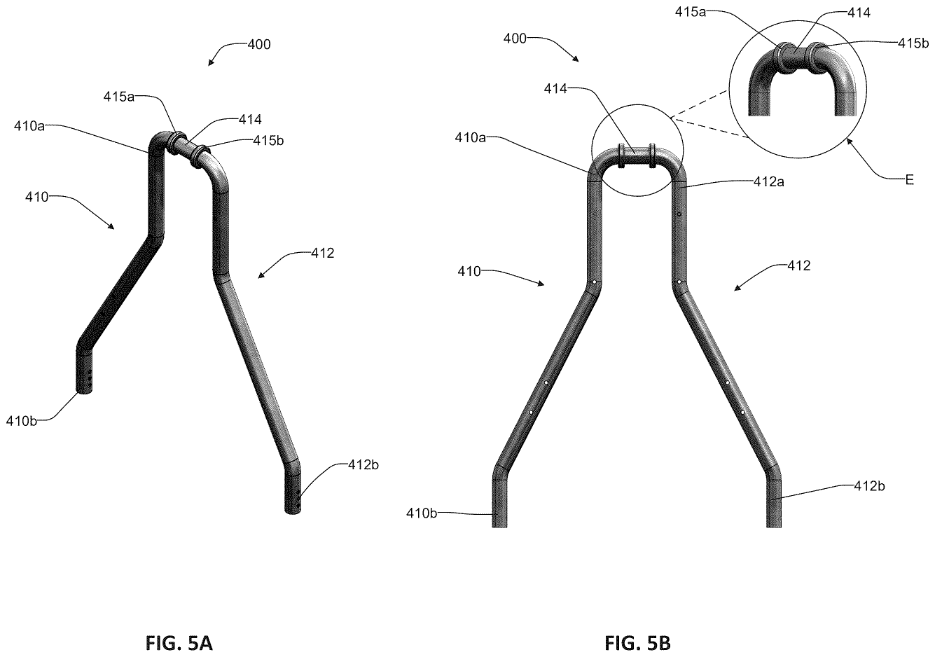

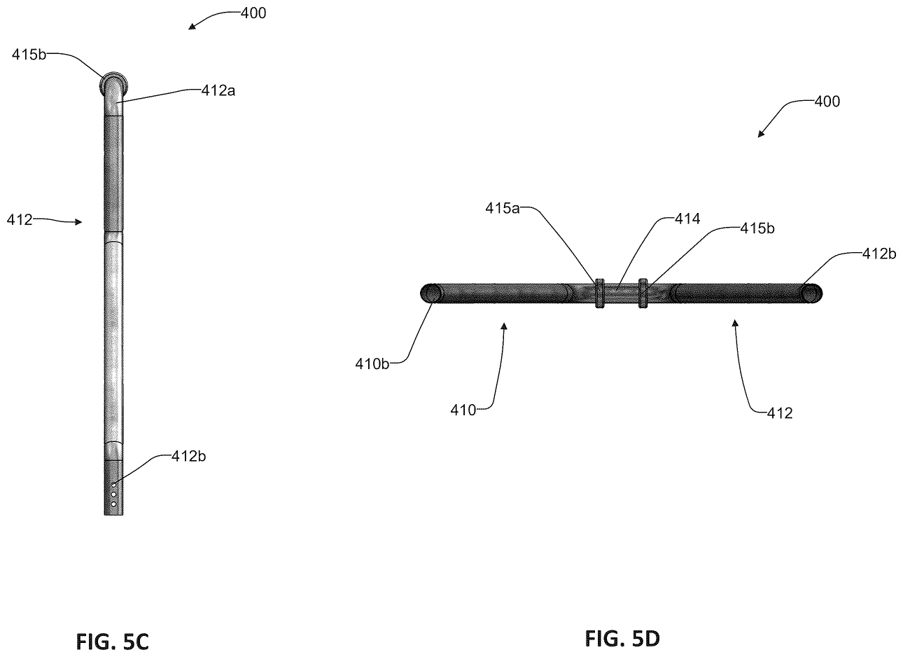

FIGS. 5A to 5D illustrate an example A-frame support 400 for a solar tracker system, such as solar tracker 10 of FIG. 1. The A-frame support 400 is like the A-frame support 100 shown in FIGS. 2A to 2D, except for the cross-sectional shape of the first leg 410, the second leg 412, and the connecting member 414. As shown in FIGS. 5A to 5D, the one or more legs may include the first leg 410 and the second leg 412 having a circular cross-section. Further, the connecting member 414 shown in Circle E in FIG. 5B, may also include a circular cross-section, and may include a first upper stop 415a and a second upper stop 415b. The first upper stop 415a and the second upper stop 415b may be configured to engage with a saddle portion of a support rail (e.g., a support rail configured to couple a solar panel to a torque tube, not explicitly shown in FIGS. 5A to 5D) to retain the saddle portion's east-west movement when coupled to the torque tube (e.g., torque tube 14). In such an example, the first leg 410, the second leg 412, and the connecting member 414 may each be formed via a hydroforming process as individual components and may be attached together to form the A-frame support 400, however this may not always be the case.

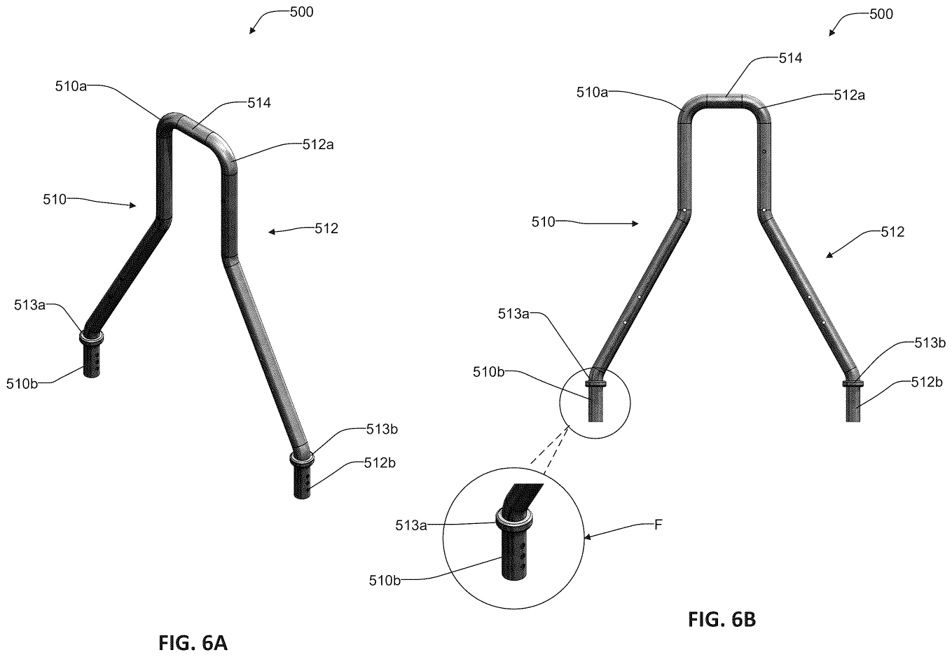

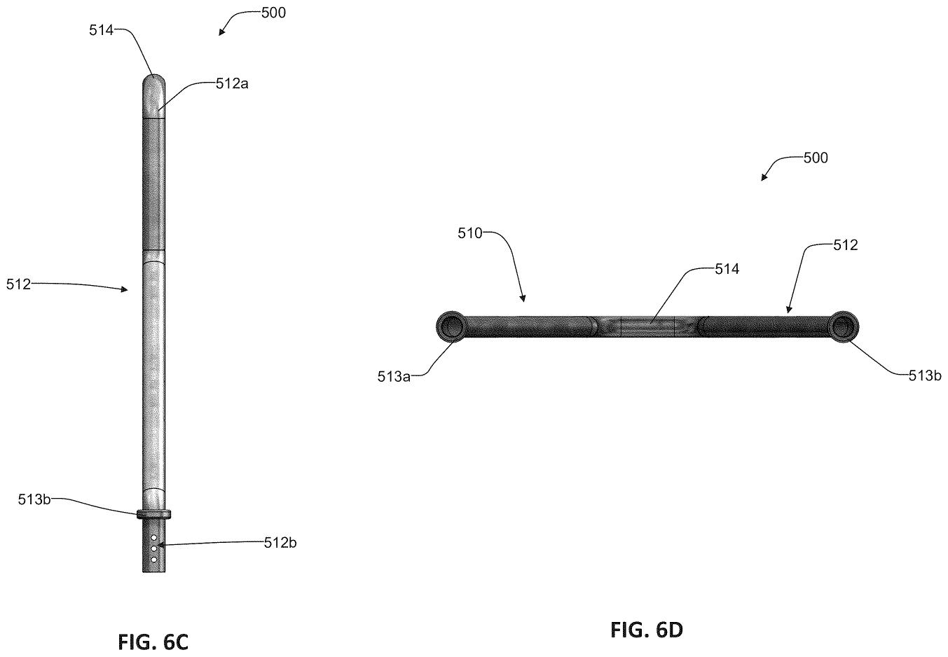

FIGS. 6A to 6D illustrate an example A-frame support 500 for a solar tracker system, such as solar tracker 10 of FIG. 1. The A-frame support 500 is like the A-frame support 100 shown in FIGS. 2A to 2D, except for the cross-sectional shape of the first leg 510, the second leg 512, and the connecting member 514. As shown in FIGS. 6A to 6D, the one or more legs may include the first leg 510 and the second leg 512 having a circular cross-section. As further shown, the connecting member 514 may also include a circular cross-section. Further, the first leg distal end 510b and the second leg distal end 512b may include a first lower stop 513a and a second lower stop 513b, respectively. The first lower stop 513a, shown in Circle F in FIG. 6B, and the second lower stop 513b may be configured to engage with a ground foundation (e.g., concrete), a ground pile, or the like, to prevent the A-frame support 500 from advancing too far into the foundation, pile, or the like. In such an example, the first leg 510, the second leg 512, and the connecting member 514 may each be formed via a hydroforming process as individual components and may be attached together to form the A-frame support 500, however this may not always be the case.

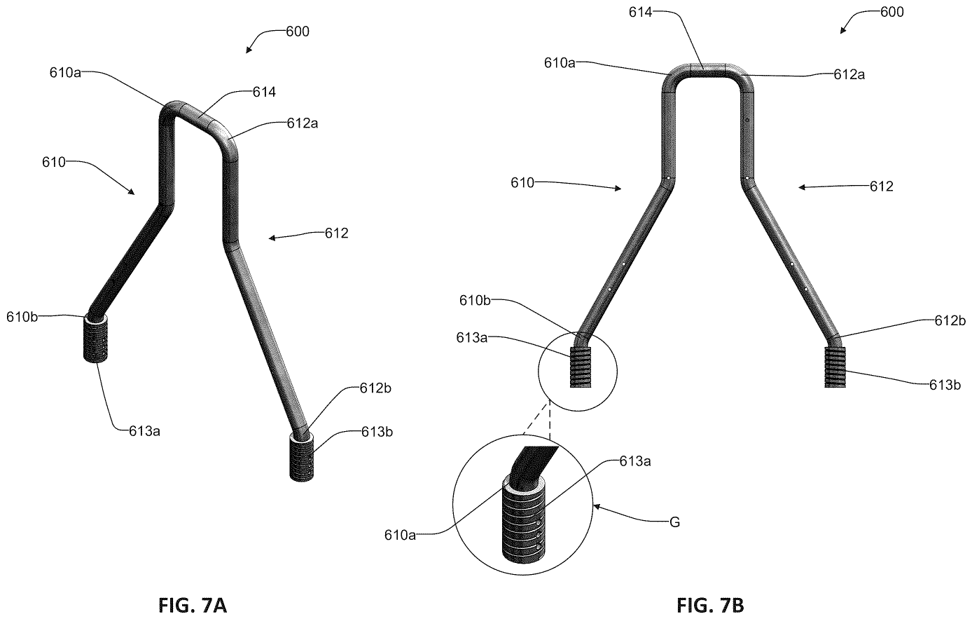

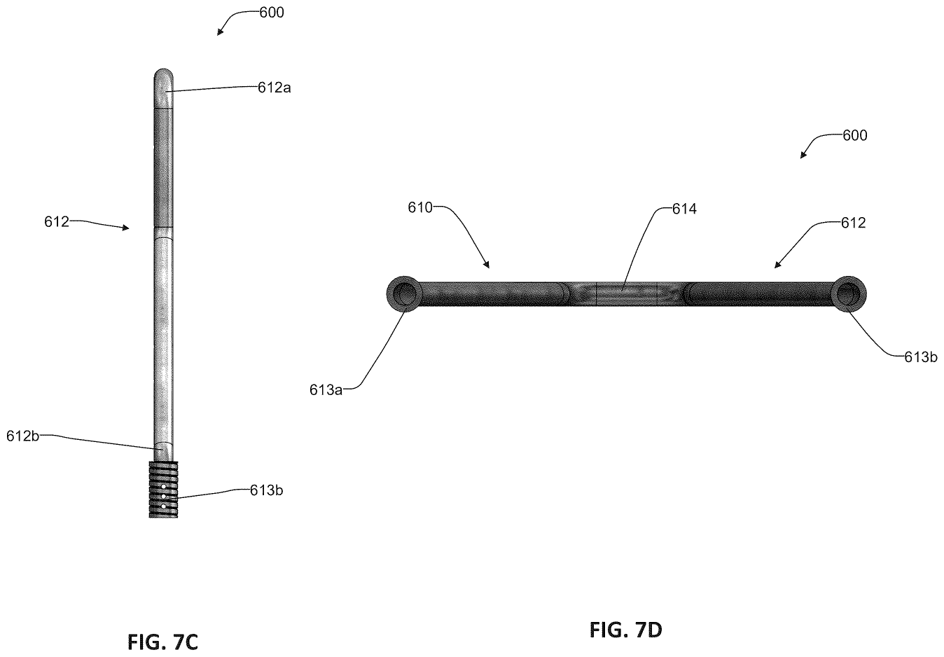

FIGS. 7A to 7D illustrate an example A-frame support 600 for a solar tracker system, such as solar tracker 10 of FIG. 1. The A-frame support 600 is like the A-frame support 100 shown in FIGS. 2A to 2D, except for the cross-sectional shape of the first leg 610, the second leg 612, and the connecting member 614. As shown in FIGS. 7A to 7D, the one or more legs may include the first leg 610 and the second leg 612 having a circular cross-section. As further shown, the connecting member 614 may also include a circular cross-section. Further, the first leg distal end 610b and the second leg distal end 612b may include a first threaded region 613a and a second threaded region 613b, respectively. The first threaded region 613a, shown in Circle G in FIG. 7B, and the second threaded region 613b may be configured to engage with a ground pile (not explicitly shown) by coupling the A-frame support 600 to the ground pile via threading. In such an example, the first leg 610, the second leg 612, the first threaded region 613a, the second threaded region 613b, and the connecting member 614 may each be formed via a hydroforming process as individual components and may be attached together to form the A-frame support 600, however this may not always be the case.

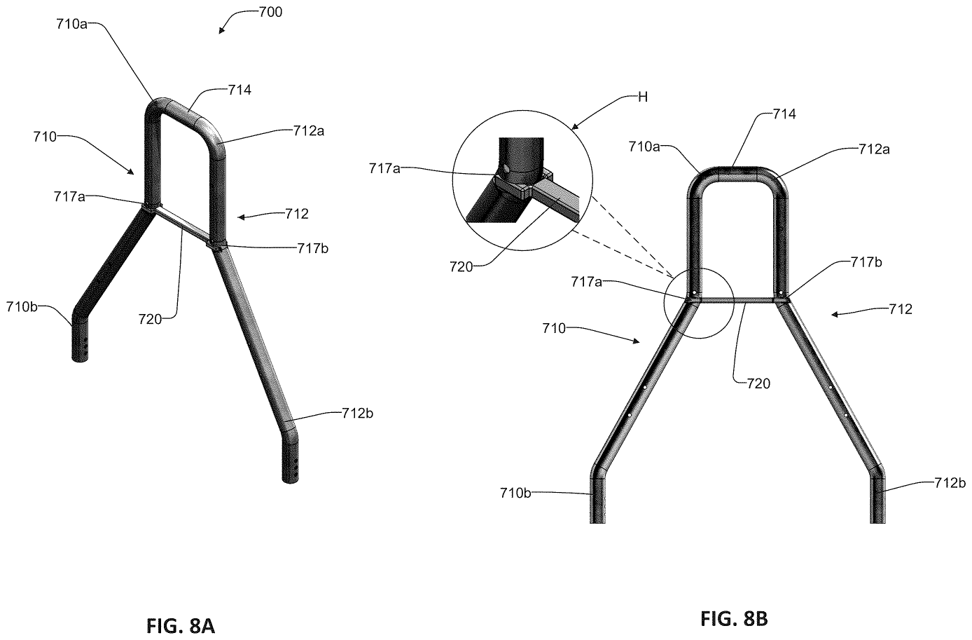

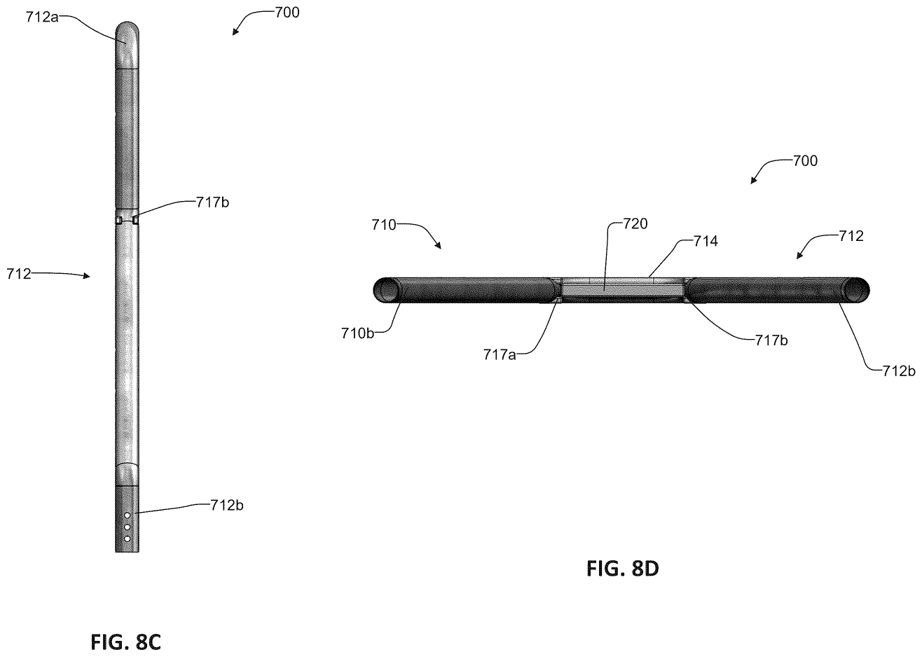

FIGS. 8A to 8D illustrate an example A-frame support 700 for a solar tracker system, such as solar tracker 10 of FIG. 1. The A-frame support 700 is like the A-frame support 100 shown in FIGS. 2A to 2D, except for the cross-sectional shape of the first leg 710, the second leg 712, and the connecting member 714. As shown in FIGS. 8A to 8D, the one or more legs may include the first leg 710 and the second leg 712 having a circular cross-section, and the connecting member 714 may further include a circular cross-section. Further, the A-frame support 700 may include a brace 720. The brace 720 may be configured to engage with a first notch 717a on the first leg 710 and a second notch 717b on the second leg 712 to lock the A-frame support 700 in position, as shown in Circle H in FIG. 8B. In such cases, the A-frame support 700 may be formed as one continuous component via a hydroforming process, and the brace 720 may be formed separately and coupled to the A-frame support 700 following processing, however this may not always be the case.

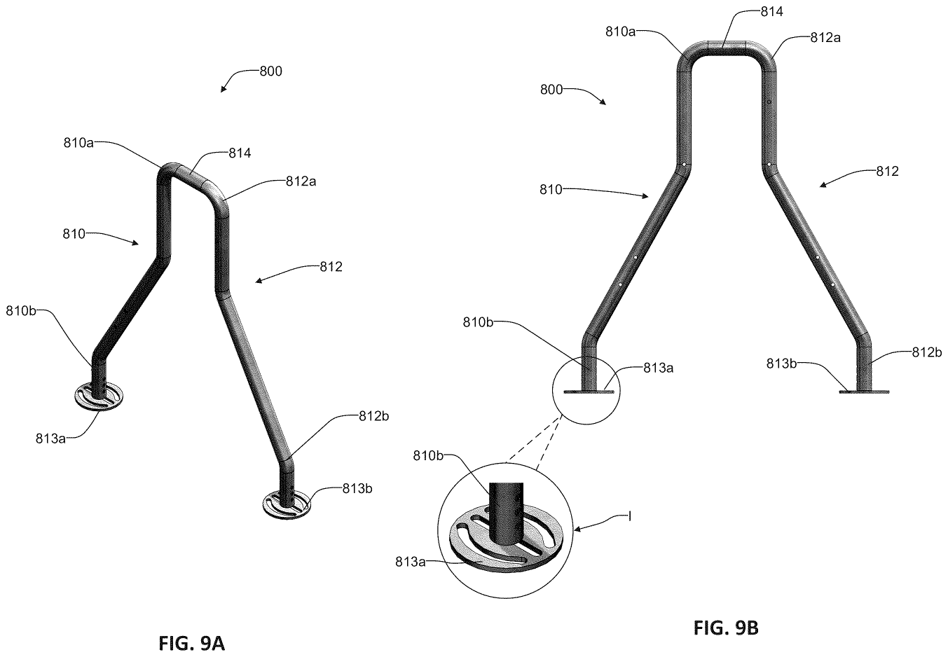

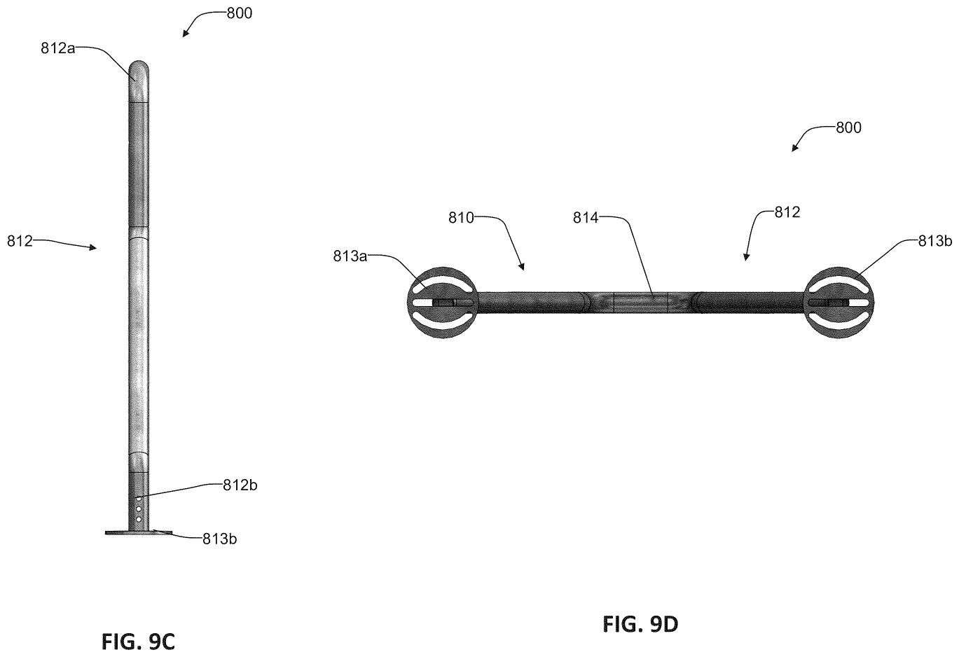

FIGS. 9A to 9D illustrate an example A-frame support 800 for a solar tracker system, such as solar tracker 10 of FIG. 1. The A-frame support 800 is like the A-frame support 100 shown in FIGS. 2A to 2D, except for the cross-sectional shape of the first leg 810, the second leg 812, and the connecting member 814. As shown in FIGS. 9A to 9D, the one or more legs may include the first leg 810 and the second leg 812 having a circular cross-section. As further shown, the connecting member 814 may also include a circular cross-section. Further, the first leg distal end 810b and the second leg distal end 812b may include a first base 813a and a second base 813b, respectively. The first base 813a, shown in Circle I in FIG. 9B, and the second base 813b may be configured to engage with a ground pile (not explicitly shown) by coupling the A-frame support 800 to the ground pile. The first base 813a and the second base 813b may be configured to be adjusted and may serve to provide stability to the A-frame support 800. In such an example, the first leg 810, the second leg 812, the first base 813a, the second base 813b, and the connecting member 814 may each be formed via a hydroforming process as individual components and may be attached together to form the A-frame support 800, however this may not always be the case

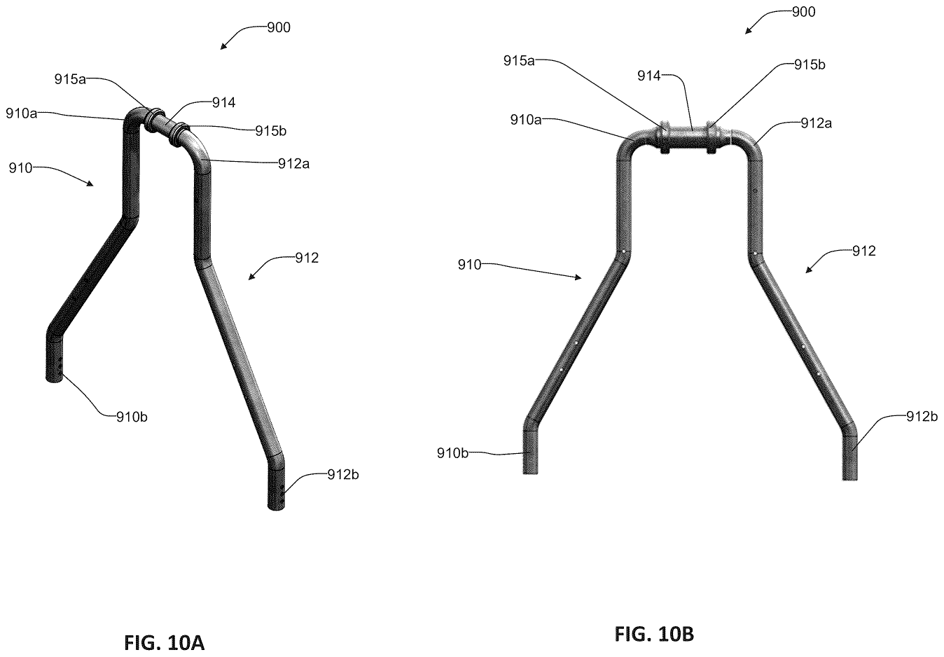

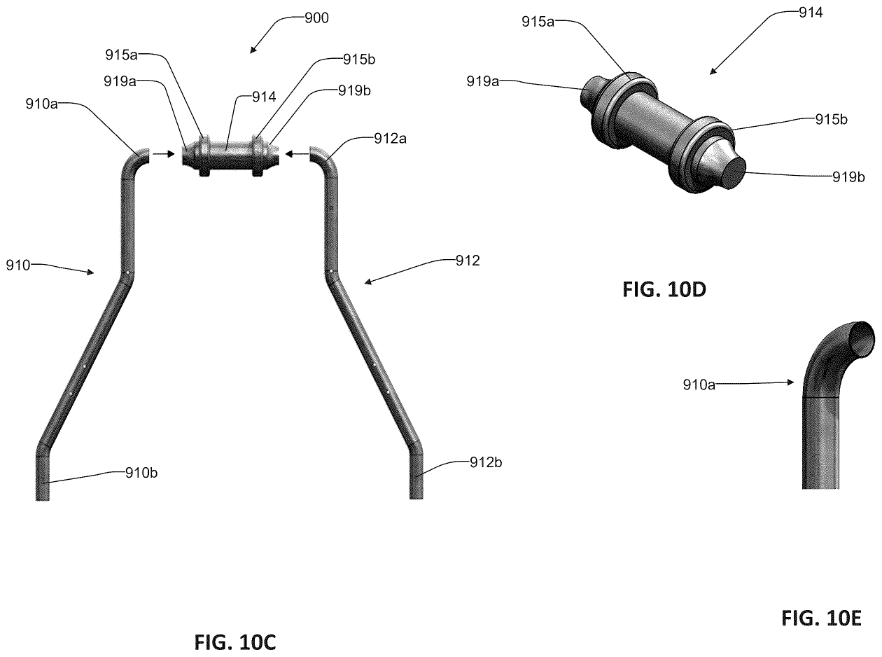

FIGS. 10A to 10E illustrate an example A-frame support 900 for a solar tracker system, such as solar tracker 10 of FIG. 1. The A-frame support 900 is like the A-frame support 100 shown in FIGS. 2A to 2D, except for the cross-sectional shape of the first leg 910, the second leg 912, and the connecting member 914. As shown in FIGS. 10A to 10E, the one or more legs may include the first leg 910 and the second leg 912 having a circular cross-section. Further, the connecting member 914 shown in FIG. 10D, may also include a circular cross-section, and may include a first upper stop 915a and a second upper stop 915b. The connecting member 914 may include swaged ends 919a, 919b beyond the first upper stop 915a and the second upper stop 915b. The first upper stop 915a and the second upper stop 915b may be configured to engage with a saddle portion of a support rail (e.g., a support rail configured to couple a solar panel to a torque tube, not explicitly shown in FIGS. 10A to 10E) to retain the saddle portion's east-west movement when coupled to the torque tube (e.g., torque tube 14). Further, the swaged ends 919a, 919b may be configured to engage with the first leg proximal end 910a and the second leg proximal end 912a, respectively, as illustrated in FIG. 10C. In such an example, the first leg 910, the second leg 912, and the connecting member 914 may each be formed via a hydroforming process as individual components and may be attached together to form the A-frame support 900, however this may not always be the case.

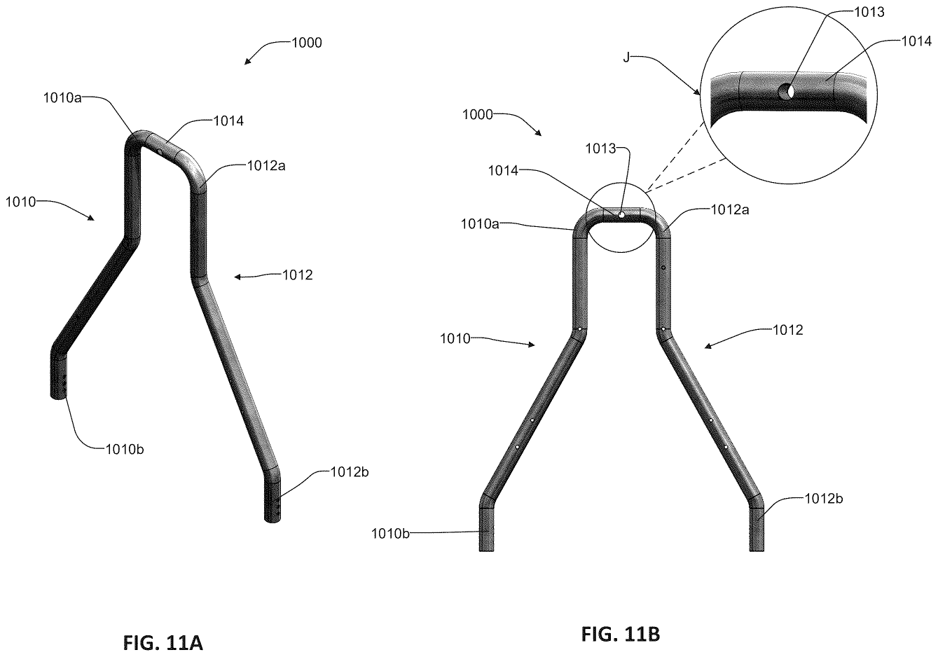

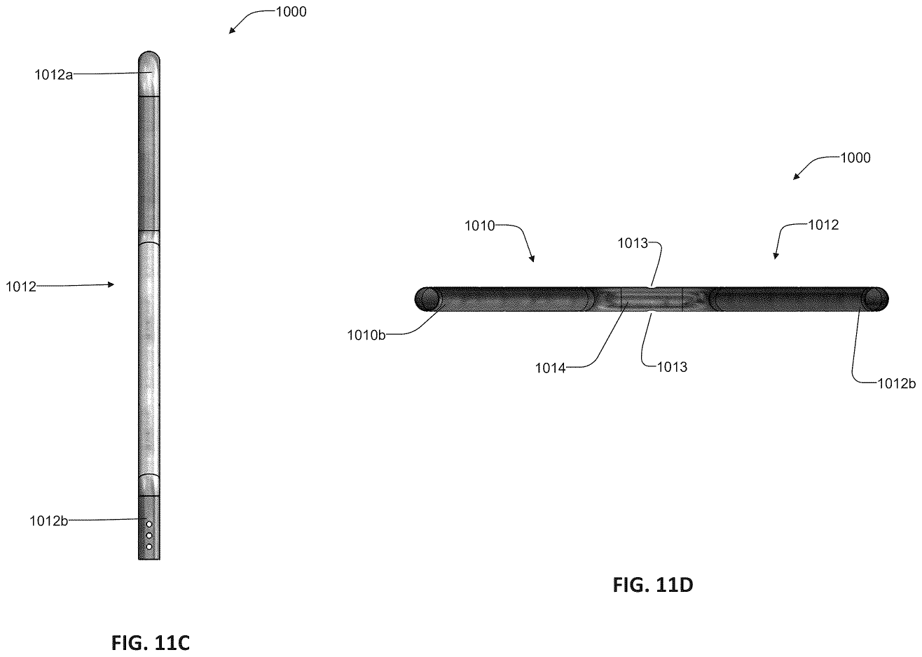

FIGS. 11A to 11D illustrate an example A-frame support 1000 for a solar tracker system, such as solar tracker 10 of FIG. 1. The A-frame support 1000 is like the A-frame support 100 shown in FIGS. 2A to 2D, except for the cross-sectional shape of the first leg 1010, the second leg 1012, and the connecting member 1014. As shown in Circle J in FIG. 11B, the connecting member 1014 may include a pivot hole 1013. The pivot hole 1013 may be configured to engage with a rail mount configured to mount a solar module to a torque tube, although not explicitly shown. The one or more legs may include the first leg 1010 and the second leg 1012 having a circular cross-section, and the connecting member 1014 may further include a circular cross-section. In such cases, the various components of the A-frame support 1000 may be formed as one continuous component via a hydroforming process, however this may not always be the case.

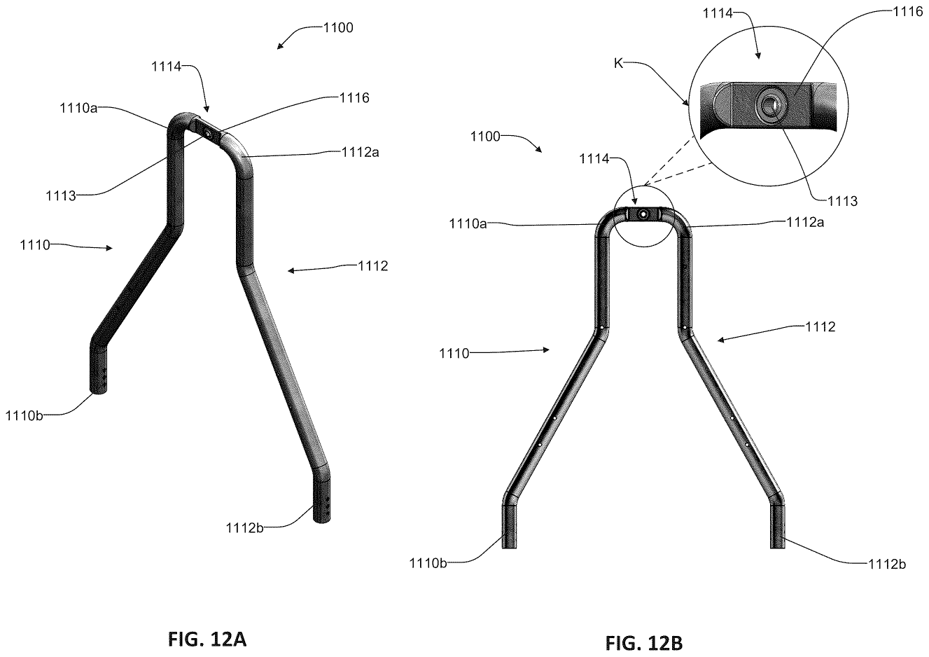

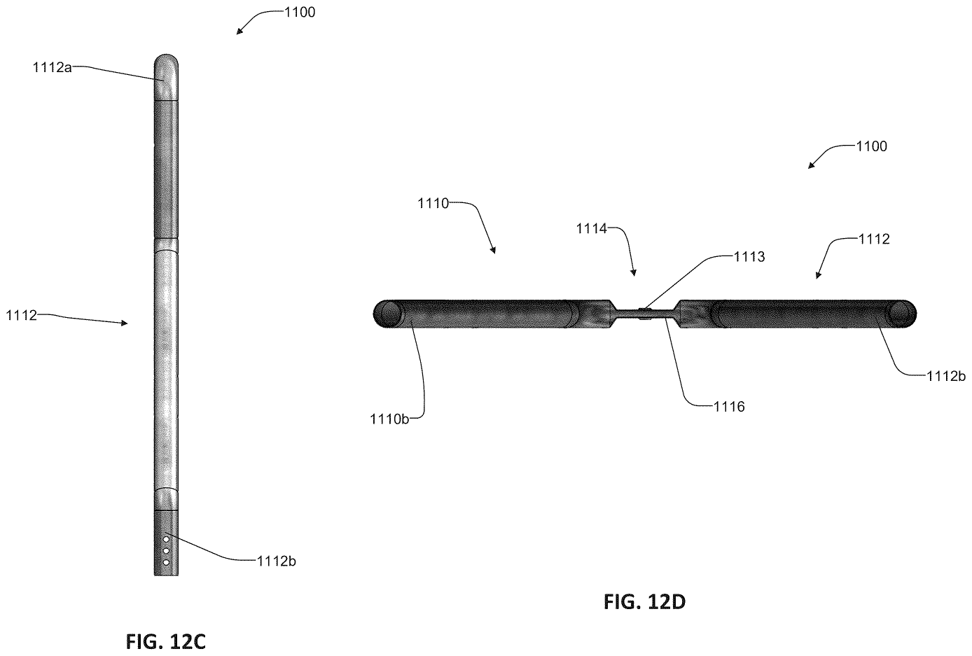

FIGS. 12A to 12D illustrate an example A-frame support 1100 for a solar tracker system, such as solar tracker 10 of FIG. 1. The A-frame support 1100 is like the A-frame support 100 shown in FIGS. 2A to 2D, except for the cross-sectional shape of the first leg 1110, the second leg 1112, and the connecting member 1114. As shown in Circle K in FIG. 12B, the connecting member 1114 may include a flat portion 1116 that may include a spherical bearing 1113. The spherical bearing 1113 may be configured to engage with a rail mount configured to mount a solar module to a torque tube, although not explicitly shown. The one or more legs may include the first leg 1110 and the second leg 1112 having a circular cross-section, and the connecting member 1114 may further include a circular cross-section with the flat portion 1116 therein. In such cases, the various components of the A-frame support 1100 may be formed as individual component via a hydroforming process and may be attached to one another, however this may not always be the case.

Various non-limiting exemplary embodiments have been described. It will be appreciated that suitable alternatives are possible without departing from the scope of the examples described herein.

What is claimed is:

1. An A-frame solar tracking pile for supporting a solar module, the A-frame solar tracking pile comprising:
a first leg including a first proximal end and a first distal end;
a second leg including a second proximal end and a second distal end; and
a connecting member connected to the first proximal end of the first leg and the second proximal end of the second leg,
wherein the first leg and the second leg are tubular members including a lumen therein.

2. The A-frame solar tracking pile of claim 1, wherein a continuous length is defined between the first leg, the connecting member, and the second leg, wherein the continuous length is an integrated, single-piece body such that no connection joint is present between the first leg, the connecting member, and the second leg.

3. The A-frame solar tracking pile of claim 1, wherein the first leg includes a first length extending between the first proximal end and the first distal end, wherein a first diameter of the first leg changes along the first length.

4. The A-frame solar tracking pile of claim 3, wherein a change in the first diameter along the first length is such that no connection joint is present.

5. The A-frame solar tracking pile of claim 1, wherein the first leg includes an interior portion configured to face the second leg and an exterior portion configured to face opposite to the second leg, wherein the interior portion includes a flat surface and wherein the exterior portion includes a round surface.

6. The A-frame solar tracking pile of claim 1, wherein the first leg includes a first lumen therein and the second leg includes a second lumen, wherein the first lumen and the second lumen are connected via the connecting member to form a continuous lumen therethrough.

7. The A-frame solar tracking pile of claim 1, wherein the connecting member extends in a lateral direction between the first leg and the second leg, wherein the first leg includes a cross-sectional oval shape having a lateral width and a longitudinal width, wherein the lateral width is greater than the longitudinal width.

8. The A-frame solar tracking pile of claim 7, wherein the connecting member includes a circular cross-section.

9. The A-frame solar tracking pile of claim 7, wherein a transition between the circular cross-section of the connecting member and the cross-sectional oval shape of the first leg does is such that no connection joint is present between the first leg and the connecting member.

10. The A-frame solar tracking pile of claim 1, wherein the connection member includes a first upper stop and a second upper stop integrally formed with the connection member, wherein the first upper stop and the second upper stop include an upper stop diameter greater than a connection member diameter of the connection member, wherein the first upper stop and the second upper stop are configured to engage a support rail of the solar module.

11. The A-frame solar tracking pile of claim 1, wherein the first leg includes a first lower stop at the first distal end and the second leg includes a second lower stop at the second distal end, wherein the first lower stop and the second lower stop include a lower stop diameter greater than a distal leg diameter of the first and second leg, wherein the first lower stop and the second lower stop are configured to engage ground piles of the solar module.

12. The A-frame solar tracking pile of claim 11, wherein the first lower stop includes a first threaded region and wherein the second lower stop includes a second threaded region.

13. The A-frame solar tracking pile of claim 1, further comprising:
a brace extending between the first leg and the second leg, wherein the brace is positioned vertically below the connecting member.

14. The A-frame solar tracking pile of claim 1, wherein the connecting member includes a first swaged end and a second swaged end, wherein the first swaged end is received within the first proximal end of the first leg and wherein the second swaged end is received within the second proximal end of the second leg.

15. The A-frame solar tracking pile of claim 1, wherein the connecting member extends in a lateral direction between the first leg and the second leg, wherein the connecting member includes a pivot hole extending in a longitudinal direction through the connecting member, the longitudinal direction substantially orthogonal to the lateral direction.

16. The A-frame solar tracking pile of claim 15, wherein the connecting member includes a flat portion, wherein the pivot hole is disposed on the flat portion, and wherein the connecting member includes a spherical bearing received within the pivot hole.

17. An A-frame solar tracking pile for supporting a solar module having a torque tube extending in a longitudinal direction, the A-frame solar tracking pile comprising:
a first leg including a first upper portion having a first proximal end and a first lower portion having a first distal end, wherein the first leg is a first tubular member having a first lumen;
a second leg including a second upper portion having a second proximal end and a second lower portion having a second distal end, wherein the second leg is a second tubular member having a second lumen; and
a connecting member extending between the first leg and the second leg in a lateral direction substantially orthogonal to the longitudinal direction,
wherein the A-frame solar tracking pile is an integrated, single-piece body such that no connection joint is present between the first leg, the connecting member, and the second leg.

18. The A-frame solar tracking pile of claim 17, wherein the connecting member includes a lumen therethrough to form a continuous lumen between the first lumen of the first leg and the second lumen of the second leg.

19. The A-frame solar tracking pile of claim 17, wherein the first lower portion and the second lower portion are oriented at a lower leg angle relative to a ground plane and wherein the first upper portion an the second upper portion are oriented at an upper leg angle relative to the ground plane, wherein the upper leg angle is greater than the lower leg angle.

20. The A-frame solar tracking pile of claim 17, wherein the first tubular member and the second tubular member are non-circular.
